(19) United States
(12) Patent Application Publication
(10) Pub. No.: US 2024/0427565 A1
(43) Pub. Date: Dec. 26, 2024

(54) AUTOCOMPLETE FEATURE FOR CODE EDITOR

(71) Applicant: Figma, Inc., San Francisco, CA (US)

(72) Inventors: Emil Sjölander, San Francisco, CA (US); Oscar Nilsson, San Francisco, CA (US); Pau Tomás, San Francisco, CA (US); Tom Duncalf, San Francisco, CA (US); Karl Petersson, San Francisco, CA (US)

(21) Appl. No.: 18/750,594

(22) Filed: Jun. 21, 2024

Related U.S. Application Data
(60) Provisional application No. 63/522,406, filed on Jun. 21, 2023.

(51) Int. Cl. G06F 8/33

(52) U.S. Cl. CPC G06F 8/33

(57) ABSTRACT

A computer system operates, or is operable to maintain a data store that includes searchable information for a graphic design, where the searchable information including text-based information associated with one or more layers of a graphic design. In response to receiving one or more character entries, the computer system performs a matching operation to match the character sequence to a term and/or value of the text-based information for one or more layers of the collection. The computer system predicts or determines a matched code line entry based on the term, value or combination of term(s) and value(s). The computer system provides, for the code editor, the predicted or matched code line entry, so as to autocomplete a portion of a code line entry with the predicted or matched code line entry.

### RELATED APPLICATIONS

This application claims benefit of priority to Provisional U.S. Patent Application No. 63/522,406, filed Jun. 21, 2023; the aforementioned priority application being hereby incorporated by reference in its entirety.

### TECHNICAL FIELD

Examples described herein relate to an autocomplete feature for a code editor.

### BACKGROUND

Software design tools have many forms and applications. In the realm of application user interfaces, for example, software design tools require designers to blend functional aspects of a program with aesthetics and even legal requirements, resulting in a collection of pages which form the user interface of an application. For a given application, designers often have many objectives and requirements that are difficult to track.

Developers are often unfamiliar with the specifics of the graphic design, which in turn can be intricate and heavily detailed. The unfamiliarity can be a source of the inefficiency for developers, who often have to look carefully of the graphic design, view annotations from designers, and write code with the specifics in mind. Not only can the task of developers be efficient, the level of detail that is often included with the graphic design can make the developers task error-prone. For example, developers can readily miss read pixel distances between object, corner attribute, and other attributes which may be difficult to view without care.

### BRIEF DESCRIPTION OF DRAWINGS

FIG. 1 illustrates an example graphic design system, according to one or more embodiments.

FIG. 2 illustrates an example method for implementing an autocomplete feature for a code editor interface, according to one or more embodiments.

FIG. 3A and FIG. 3B illustrate an example of a code editor interface for implementing an autocomplete feature, according to one or more embodiments.

FIG. 4 illustrate another example of a code editor interface for implementing an autocomplete feature, according to one or more embodiments.

FIG. 5 illustrates a computer system on which one or more embodiments can be implemented.

FIG. 6 illustrates a user computing device for use with one or more examples, as described.

### DETAILED DESCRIPTION

According to examples, a data store is maintained that includes searchable information for a graphic design. The searchable information can include text-based information that includes text identifiers, attributes and attribute values for a collection of layers that comprise the graphic design, where each layer corresponds to an object, group of objects or a type of object. Further, each layer may be associated with a set of attributes, including a text identifier. A character sequence is received via a code editor interface. The character sequence corresponds to a partial code line entry. A matching operation is performed to match the character sequence to a term and/or value of one or more layers of the collection. A predicted code line entry is determined based on the matching term and/or value. The predicted code line entry is provided to the code editor, so as to autocomplete the partial code line entry with the predicted code line entry.

In examples, a code line entry corresponds to a term, value or combinations of terms and/or values.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System Description

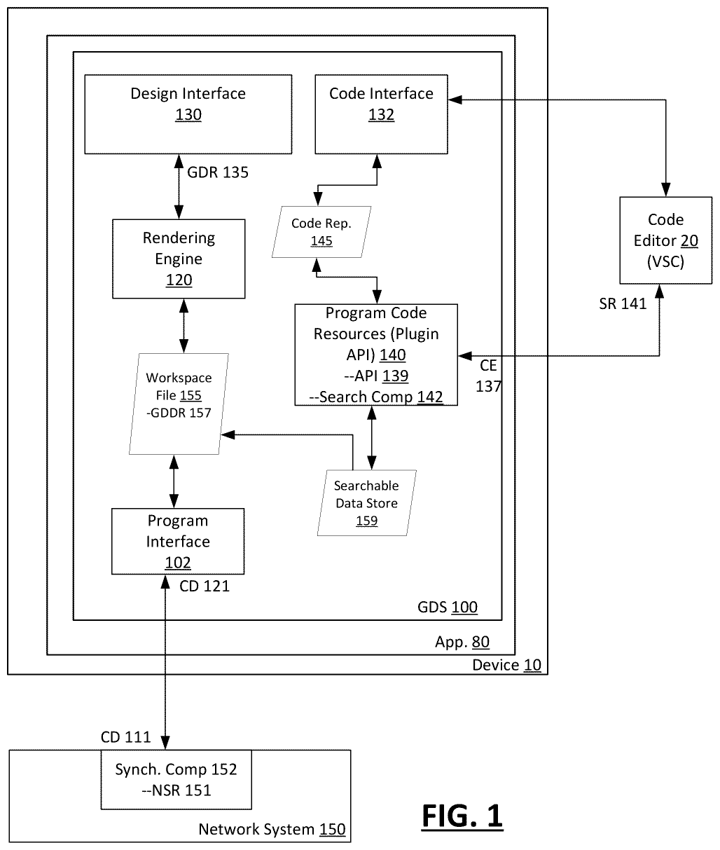

FIG. 1 illustrates a graphic design system, according to one or more embodiments. A graphic design system 100 (“GDS 100”) as described with FIG. 1 can be implemented in any one of multiple different computing environments, including as a device-side application, as a network service, and/or as a collaborative platform. In examples, the GDS 100 can be implemented using a web-based application 80 that executes on a user device 10. In other examples, the GDS 100 can be implemented through use of a dedicated web-based application. As an addition or alternative, one or more components of the GDS 100 can be implemented as distributed system, such that processes described with various examples execute on both a network computer (e.g., server) and on the user device 10.

In examples, the GDS 100 includes processes that execute through a web-based application 80 that is installed on the computing device 10. The web-based application 80 can execute scripts, code and/or other logic to implement functionality of the GDS 100. Additionally, in some variations, the GDS 100 can be implemented as part of a network service, where web-based application 80 communicates with one or more remote computers (e.g., server used for a network service) to executes processes of the GDS 100.

In examples, a user device 10 includes a web-based application 80 that loads processes and data for implementing the GDS 100 on a user device 10. The GDS 100 can include a rendering engine 120 that enables users to create, edit and update graphic design files. Further, the GDS 100 can include a code integration sub-system that combines, or otherwise integrates programming code, data, assets and other logic for developing a graphic design as part of a production environment.

In some examples, web-based application 80 retrieves programmatic resources for implementing the GDS 100 from a network site. As an addition or alternative, web-based application 80 can retrieve some or all of the programmatic resources from a local source (e.g., local memory residing with the computing device 10). The web-based application 80 may also access various types of data sets in providing functionality such as described with the GDS 100. The data sets can correspond to files and libraries, which can be stored remotely (e.g., on a server, in association with an account) or locally.

According to examples, a user operates web-based application 80 to access a network site, where programmatic resources are retrieved and executed to implement the GDS 100. A user can initiate a session to implement the GDS 100 to view, create and edit a graphic design, as well as to generate program code for implementing the graphic design in a production environment. In some examples, the user can correspond to a designer that creates, edits and refines the graphic design for subsequent use in a production environment.

In examples, the web-based application 80 can correspond to a commercially available browser, such as GOOGLE CHROME (developed by GOOGLE, INC.), SAFARI (developed by APPLE, INC.), and INTERNET EXPLORER (developed by the MICROSOFT CORPORATION). In such examples, the processes of the GDS 100 can be implemented as scripts and/or other embedded code which web-based application 80 downloads from a network site. For example, the web-based application 80 can execute code that is embedded within a webpage to implement processes of the GDS 100. The web-based application 80 can also execute the scripts to retrieve other scripts and programmatic resources (e.g., libraries) from the network site and/or other local or remote locations. By way of example, the web-based application 80 may execute JAVASCRIPT embedded in an HTML resource (e.g., web-page structured in accordance with HTML 5.0 or other versions, as provided under standards published by W3C or WHATWG consortiums). In other variations, the GDS 100 can be implemented through use of a dedicated application, such as a web-based application.

The GDS 100 can include processes represented by programmatic interface 102, rendering engine 120, design interface 130, code interface 132 and program code resources 140. Depending on implementation, the components can execute on the user device 10, on a network system (e.g., server or combination of servers), or on the user device 10 and a network system (e.g., as a distributed process).

The programmatic interface 102 includes processes to receive and send data for implementing components of the GDS 100. Additionally, the programmatic interface 102 can be used to retrieve, from local or remote sources, programmatic resources and data sets which collectively comprise a workspace file 155 of the user or user's account. In examples, the workspace file 155 includes one or more data sets (represented by “graphic design data set 157”) that represent a corresponding graphic design that can be rendered by rendering engine 120. The workspace file 155 can include one or more graphic design data sets 157 which collectively define a design interface. The graphic design data set 157 can be structured as one or more nodes that are hierarchically arranged. Each node can be associated with a corresponding set of properties and property values which collectively provide information that defines, or otherwise describes the design element that is represented by the node. As an addition or variation, the graphic design data set 157 can be structured to define the graphic design 125 as a collection of layers, where each layer corresponds to an object (e.g., frame, image, text), group of objects, or specific type of object. In examples, each layer corresponds to a separate section of the graphic design 135 that includes a set of design elements or objects. Further, in some examples, the graphic design data set 157 can be structured to organize the graphic design 135 as a collection of cards, pages, or section.

According to an aspect, the programmatic interface 102 also retrieves programmatic resources that include an application framework for implementing the design interface 130. The design interface 130 can utilize a combination of local, browser-based resources and/or network resources (e.g., application framework) provided through the programmatic interface 102 to generate interactive features and tools that can be integrated with a rendering of a graphic design 135 on a canvas. The design interface 130 can enable a user to view and edit aspects of the graphic designs. In this way, the design interface 130 can be implemented as a functional layer that is integrated with a canvas on which a graphic design 135 is provided.

The design interface 130 can detect and interpret user input, based on, for example, the location of the input and/or the type of input. The location of the input can reference a canvas or screen location, such as for a tap, or start and/or end location of a continuous input. The types of input can correspond to, for example, one or more types of input that occur with respect to a canvas, or design elements that are rendered on a canvas. Such inputs can correlate to a canvas location or screen location, to select and manipulate design elements or portions thereof. Based on canvas or screen location, a user input can also be interpreted as input to select a design tool, such as may be provided through the application framework. In implementation, the design interface 130 can use a reference of a corresponding canvas to identify a screen location of a user input (e.g., ‘click’). Further, the design interface 130 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices.

In some examples, the rendering engine 120 and/or other components utilize graphics processing unit (GPU) accelerated logic, such as provided through WebGL (Web Graphics Library) programs which execute Graphics Library Shader Language (GLSL) programs that execute on GPUs. In variations, the web-based application 80 can be implemented as a dedicated web-based application that is optimized for providing functionality as described with various examples. Further, the web-based application 80 can vary based on the type of user device, including the operating system used by the user device 10 and/or the form factor of the user device (e.g., desktop computer, tablet, mobile device, etc.).

In examples, the rendering engine 120 uses the graphic design data set 157 to render the graphic design 135 with the design interface 130, where the graphic design 135 includes graphic elements, attributes and attribute values. Each attribute of a graphic element can include an attribute type and an attribute value. For an object, the types of attributes include, shape, dimension (or size), layer, type, color, line thickness, text size, text color, font, and/or other visual characteristics. Depending on implementation, the attributes reflect properties of two- or three-dimensional designs. In this way, attribute values of individual objects can define, for example, visual characteristics of size, color, positioning, layering, and content, for elements that are rendered as part of the design.

The graphic design 135 can organize the graphic design by screens (e.g., representing production environment computer screen), pages (e.g., where each page includes a canvas on which a corresponding graphic design is rendered) and sections (e.g., where each screen includes multiple pages or screens). The user can interact, via the design interface 130, with the graphic design 135 to view and edit aspects of the graphic design. The design interface 130 can detect the user input, and the rendering engine 120 can update the graphic design 135 in response to the input. For example, the user can specify input to change a view of the graphic design 135 (e.g., zoom in or out of a graphic design), and in response, the rendering engine 120 updates the graphic design 135 to reflect the change in view. The user can also edit the graphic design 135. The design interface 130 can detect the input, and the rendering engine 120 can update the graphic design data set 157 representing the updated design. Additionally, the rendering engine 120 can update the graphic design 135, where changes made by a user are instantly displayed to the user.

### Collaborative Environment

In examples, the GDS 100 can be implemented as part of a collaborative platform, where a graphic design can be viewed and edited by multiple users operating different computing devices at locations. As part of a collaborative platform, when the user edits the graphic design, the changes made by the user are implemented in real-time to instances of the graphic design on the computer devices of other collaborating users. Likewise, when other collaborators make changes to the graphic design, the changes are reflected in real-time with the graphic design data set 157. The rendering engine 120 can update the graphic design 135 in real-time to reflect changes to the graphic design by the collaborators.

In implementation, when the rendering engine 120 implements a change to the graphic design data set 157, corresponding change data 111 representing the change can be transmitted to the network system 150. The network system 150 can implement one or more synchronization processes (represented by synchronization component 152) to maintain a network-side representation 151 of the graphic design 135. In response to receiving the change data 111 from the user device 10, the network system 150 updates the network-side representation 151 of the graphic design 135, and transmits the change data 111 to user devices of other collaborators. Likewise, if another collaborator makes a change to the instance of the graphic design on their respective device, corresponding change data 111 can be communicated from the collaborator device to the network system 150. The synchronization component 152 updates the network-side representation 151 of the graphic design 135, and transmits corresponding change data 121 to the user device 10 to update the graphic design data set 157. The rendering engine 120 then updates the graphic design 135.

### Code Generation

In examples, the GDS 100 includes processes represented by program code resources 140 to generate code data for a code representation 145 of the graphic design. The program code resources 140 can include processes to access graphic design data set 157 of workspace file 155, and to generate code data that represent elements of the graphic design. The generated code data can include production environment executable instructions (e.g., JavaScript, HTML, etc.) and/or information (e.g., CSS (or Cascading Style Sheets), assets (e.g., elements from a library) and other types of data.

In some examples, the graphic design data set 157 is structured to define multiple layers, where each layer corresponds to one of an object, a group of objects or a specific type of object. In specific examples, the types of layers can include a frame object, a group of objects, a component (i.e., an object comprised of multiple objects that reflect a state or other variation between the instances), a text object, an image, configuration logic that implements a layout or positional link between multiple objects, and/or other predefined types of elements. For each layer of the graphic design, the program code resources 140 generates a set of code data that is associated with, or otherwise linked to the design element. For example, each layer of the graphic design data set 157 can include an identifier, and the program code resources 140 can, for each layer, generate a set of code data that is associated with the identifier of the layer. The program code resources 140 can generate the code representation 145 such that code line entries and elements of the code representation 145 (e.g., line of code, set of executable information, etc.) are associated with a particular layer of the graphic design 135. The associations can map code line entries of the code representation 145 to corresponding design elements (or layers) of the graphic design 135 (as represented by the graphic design data set 157). In this way, each line of code of the code representation 140 can map to a particular layer or design element of the graphic design. Likewise, in examples, each layer or design element of the graphic design 135 can map to a segment of the code representation 145.

### Code Representation Rendering

In some examples, the code interface 132 renders an organized presentation of code representation 145 for a production-environment rendering of the graphic design 135. For example, the code interface 132 can visually segment a presentation of the code representation 145 into separate segments where production-environment executable code instructions is displayed (e.g., separate areas for HTML and CSS code). Further, the code interface 132 can include a segment that visually identifies assets used in the graphic design 135, such as design elements that are part of a library associated with a library of an account associated with the user.

The code interface 132 can implement a combination of local, browser-based resources and/or network resources (e.g., application framework) provided through the programmatic interface 102 to generate a set of interactive features and tools for displaying the code representation 145. As described with examples below, the code interface 132 can enable elements of the code representation 145 to be individually selectable as input, to cause a represented design element to be selected, or navigated to, on the design interface 130. For example, the user may select, as input, one or more of the following (i) a line of code, (ii) a portion of a line of code corresponding to an attribute, or (iii) portion of a line of code reflecting an attribute value. Still further, a user can select program code data displayed in different areas, program code of different types (e.g., HTML or CSS), assets, and other programmatic data elements.

### Selecting Code to View Design Elements

The code interface 132 can detect user input to select a code element. In response to detecting user input to a specific code element, the code interface 132 can identify the associated design element(s) (or layer) associated with that code element to the design interface 130. For example, the code interface 132 can identify a particular layer that is indicated by the selection input of the user. The code interface 132 can indicate the identified layers or design elements to the design interface 130, to cause the design interface 130 to highlight, navigate to or otherwise display in prominence the design element(s) that are associated with the selected code elements. In some examples, the design interface 130 can visually indicate design element(s) associated with code elements that are selected through the code interface 132 in isolation, or separate from other design elements of the graphic design. In such case, other design elements of the graphic design can be hidden, while the associated design element is displayed in a window of the design interface 130. In this way, when the user interacts with the code interface 132, the user can readily distinguish the associated design element from other design elements of the graphic design.

### Selecting Code to Navigate to Design Element

Further, the selection of a code element in the code interface 132 can cause the design interface 130 to navigate to the particular set of design elements that are identified by the selected code element. For example, the code interface 132 can identify the layer that is selected by the user input, and the design interface 130 can navigate a view of the graphic design 135 to a canvas location where the associated design element is provided. As an addition or variation, the design interface 130 can navigate by changing magnification level of the view, to focus in on specific design elements that are associated with the identified design element.

### Synchronizing Design and Code Interface

In examples, the design interface 130 and the code interface 132 can be synchronized with respect to the content that is displayed through each interface. For example, the code interface 132 can be provided as a window that is displayed alongside or with a window of the design interface 130. In an aspect, the code interface 132 displays code elements that form a portion of the code representation, where each code element is associated with a layer or design element having a corresponding identifier. In turn, the design interface 130 uses the identifiers of the layers/design elements to render the design elements of the graphic design 135 that coincide with the code elements displayed by the code interface 132.

Further, the GDS 100 can implement processes to keep the content of the design interface 130 linked with the content of the code interface 132. For example, if the user scrolls the code data displayed through the code interface 132, the design interface 130 can navigate or center the rendering of the graphic design 135 to reflect the code elements that are in view with the code interface 132. As described, the design interface 130 and the code interface 132 can utilize a common set of identifiers for the layers or design elements, as provided by the graphic design data set 157.

### Modifying Graphic Design Through Code Interface

In examples, a user of device 10 can modify the graphic design 135 by changing the code representation 145 using the code interface 132. For example, a user can select a code segment of the representation 145 displayed through the code interface 132, and then change an attribute, attribute value or other aspect of the code element. The input to change the code representation 145 can automatically change a corresponding design element of the graphic design 135. The design interface 130 can identify and change the layer or design element of the changed code segment, and the change can be reflected in the graphic design data set 157. In response, the rendering engine 120 can update the rendering of the graphic design 135, to reflect the change made through the code interface 132. In this way, a developer can make real-time changes to, for example, a design interface to add, remove or otherwise modify (e.g., by change to attribute or attribute value) a layer or design element.

### Viewing and Modifying Code Elements Through Design Interface

Additionally, in examples, a user can select design elements of the graphic design 135 through interaction with the design interface 130. For example, a user can select or modify a layer of the graphic design 135, and the design interface 130 can display a corresponding segment of the code representation 145 layer via the code interface 132. As an addition or variation, the code interface 132 can highlight or otherwise visually distinguish code elements (e.g., lines of code) that are associated with the identified design element from a remainder of the code representation 145. In this way, a developer can readily inspect the code elements generated for a design element of interest by selecting a design element, or a layer that corresponds to the design element in the design interface 130, and viewing the code generated for the selected element or layer in the code interface 132.

Further, in examples, the user can edit the graphic design 135 through interaction with the design interface 130. The rendering engine 120 can respond to the input by updating the graphic design 135 and the graphic design data set 157. When the graphic design data set 157 is updated, the program code resources 140 can update the code representation 145 to reflect the change. Further, the code interface 132 can highlight, display in prominence or otherwise visually indicate code elements that are changed as a result of changes made to the graphic design 135 via the design interface 130.

### Code Editor Autocomplete

A code editor corresponds to a human-interface that is optimized for enabling users to write and edit program code (e.g., executable programs, routines etc.). In some examples, the GDS 100 includes resources for enabling use of a code editor 20 to leverage data from a workspace file 155 of a graphic design. The code editor 20 can be used to create and/or edit the code representation 145 for implementing the graphic design 135 in a production-environment.

In examples, program code resources 140 can include a code generator to generate code and data that represents a graphic design of the workspace file 155. The program code resources 140 can include an application programming interface (API) 139 that communicates with, for example, an external source that provides the code editor 20 for users of the GDS 100. In examples, auto-generated code can be used to generate the code representation 145, and the code editor 20 is used to update the code representation 145. In variations, the code representation 145 is created and updated by a developer using a code interface 132.

In variations, the code editor 20 can be provided with the GDS 100, such as on the user device 10. Further, updates to the code representation 145 can be made based on changes made with the code editor 20.

In some examples, the code editor 20 can be implemented or otherwise provided by a remote source. The API 139 can enable a communication channel where various types of events are monitored and detected. For example, changes to the code representation 145 can be detected and used to update the local instance of the code representation 145 on the user device 10. Additionally, user interactions with the code editor 20 can be detected via the API 139. For example, individual key entries 137 of the user interacting with the code editor 20 can be detected via the API 139.

According to some examples, the program code resources 140 can provide a search component for the code editor 20. To search component 142 can be responsive to certain types of input, such as individual character entries 137, or a sequence of character entries 137. In response to receiving one or more character entries 137, the search component 142 implements a search or matching operation to identify text data associated with the graphic design, and to communicate a response back to the code editor 20. As described with some examples, the search component 142 implements one or more search routines to match one or more character entries 137 that correspond to a portion of a code line entry. In response to detecting one or more character entries 137 (or sequence thereof), the search component 142 performs the matching operations to identify one or more matching entries for the search result 141. The search result 141 can include one or more suggestions to the code editor 20, where each suggestion auto completes a portion or remainder of a code line entry that was in progress.

In some examples, the GDS 100 includes a searchable data store 159 that is based on, or representative of, the graphic design data set 157. For example, the searchable data store 159 can be based on, or otherwise correspond to, the graphic design data set 157, with optimizations for alphanumeric searching. For example, at least portions of the searchable data store 159 can be structured as an index that maps sequences of character entries to text-based attributes and descriptors of the layers, as provided by the graphic design data set 157 in its structured representation of the graphic design 135. The searchable data store 159 can also be updated at the same as when the graphic design data set 157 is updated, such that the searchable data store 159 includes recent edits to the graphic design 135.

In some examples, the searchable data store 159 identifies terms and/or values of text-based information associated with layers, nodes or segments of the graphic design 135. The terms can include text identifiers (e.g., names of objects), property (or attribute) identifiers and other text-based information which may be determined from the graphic design data set 157 (e.g., names and descriptors of nodes or layers, etc.), and the values can include field or property values. The identified terms and/or values can be associated with snippets of code, where the code snippets are determined from, for example, the code repository 145 and/or auto-generated. In variations, the identified terms and/or values are linked to data for generating snippets of code. Accordingly, in examples, the snippets of code include one or more lines of code, or partial lines of code, which are (or can be) integrated with the code representation 145 of the graphic design 135. In this way, the snippets can be generated to provide portions of executable code (e.g., for production environment), and code that can be compiled with the code representation 145.

In response to receiving a character entry (or sequence of character entries), the search component 142 implements a search operation using the searchable data store 159, to identify one or more matching terms or values. The matching terms and values can be determined from text-based information associated with one or more layers or nodes of the graphic design data set 157. Further, each of the matching terms or values can be associated with, or otherwise link to, one or more code snippets.

The search component 142 can return, to the code editor 20, via the API 139, the search result 141. The search result 141 can include a predicted or matched code line entry, wherein the predicted or matched code line entry completes at least a portion of the code line that the user was in the process of entering (e.g., when entering character entries 137). As described with examples, a predicted or matched code line entry can reference or otherwise include a matching identifier or descriptor of a layer of the graphic design 135. As an addition or variation, the predicted or matched code line entry can reference or otherwise include an attribute value that is included with, or determined from, the graphic design data set 157. Still further, other descriptors or file specific information can be returned by the search operation.

As an addition or variation, the result 141 returned by the search component 142 can include a set of multiple possible code line entries (i.e., “a candidate set of code line entries”). Further, the search component 142 can be configured to use subsequent character entries to filter matching code line entries from the candidate set. For example, with each character entry 137, the search component 142 can perform a search of the searchable data store 159, and return a candidate set of code line entries. With each subsequent character entry 137, the candidate set can reduce in number, as the number of candidate entries that match the sequence of character entries 137 dwindles in number.

In examples, the code line entries of a candidate set, returned in response to a search result 141, may be ranked, to reflect a likelihood that individual code line entries of the candidate set are being referenced by the character entry or entries of the user. The ranking can be based on the term or value that is matched to the character entry (or entries) 137. Further, the ranking can be based on one or more weights. In some examples, ranking (or weights) can be based on a count of the number of times the particular term or value that is matched to the character entry or entries 137 appears in the searchable data store 159 and/or the graphic design data set 157. In variations, the rank or weighting can be based on a recency of the matching term or value. Still further, the ranking/weight can be based on context, such as information pertaining to the layer or node which a developer is coding. Still further, in other variations, the ranking can be based on the snippet of code associated with each matched term or value. Various other weights and methodologies can be used to rank the candidate set of entries for the search result 141.

### Methodology

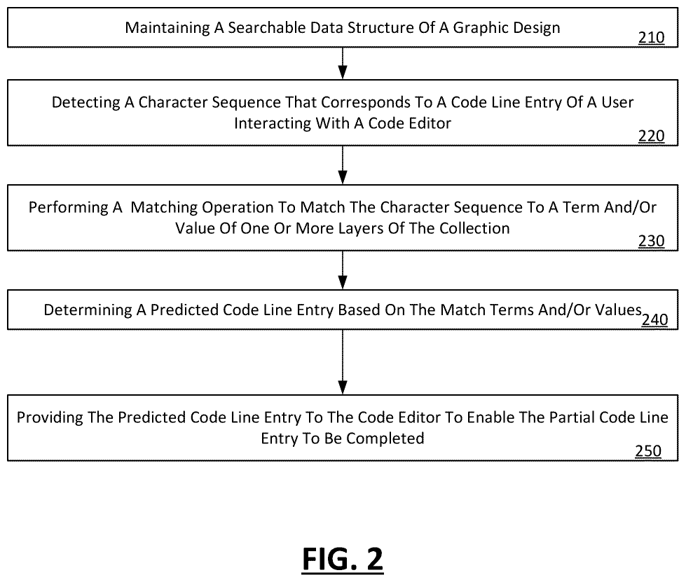

FIG. 2 illustrates an example method for implementing an autocomplete feature for a code editor interface, according to one or more examples. A method such as described with an example of FIG. 2 can be implemented using components and processes described with FIG. 1. Accordingly, reference may be made to elements of FIG. 1 for purpose of illustration.

In step 210, a searchable data store 159 is maintained for a graphic design. The searchable data store can include text-based information that is determined from a collection of layers or nodes of the graphic design. The text-based information can include text identifiers, properties (or attribute) identifiers, and property or attribute values for a collection of layers that comprise a graphic design, where each layer corresponds to an object, group of objects or a type of object. Further, each layer may be associated with a set of attributes, including a text identifier and other descriptors. In some examples, the searchable data store 159 can also include code snippets or a reference to code snippets.

In step 220, one or more characters are received via the code editor 20, where the received character, or sequence of characters, can be matched or otherwise correspond to a partial code line entry. In examples, the character sequence can correspond to a partial entry of a term (e.g., name, identifier, property type, etc.), value, command and/or expression.

In step 230, a matching operation is performed to match the character, or sequence of characters, to a term, value or combination of term(s) and value(s) of the searchable data store 159. The matched, value or combination of term(s) and/or value(s) of the collection can correspond to, for example, an identifier (e.g., property/attribute name), descriptor or attribute/attribute value of the layer.

In step 240, a matched or predicted code line entry is determined based on the matched term(s) and/or value(s), such as a set of attributes of a matched layer. The matched or code line entry can be associated with the matched term(s) and/or value(s). In variations, the matched term(s) and/or value(s) can be used to generate code snippets. Still further, in examples, the matched or predicted code line entry can include the matched term(s), value(s) or combination of term(s) and value(s). In some variations, the predicted code line entry can include additional text, terms or information, such as non-specific information or terms.

In step 250, the predicted code line entry is provided as a selectable feature to the code editor 20. Upon selection by the user, the predicted code line entry can be used to autocomplete a partial code line entry of the user. The update can, for example, update a code repository for implementing the graphic design 135 in the production library. Further, the code repository can be used to update the code representation 145.

### EXAMPLES

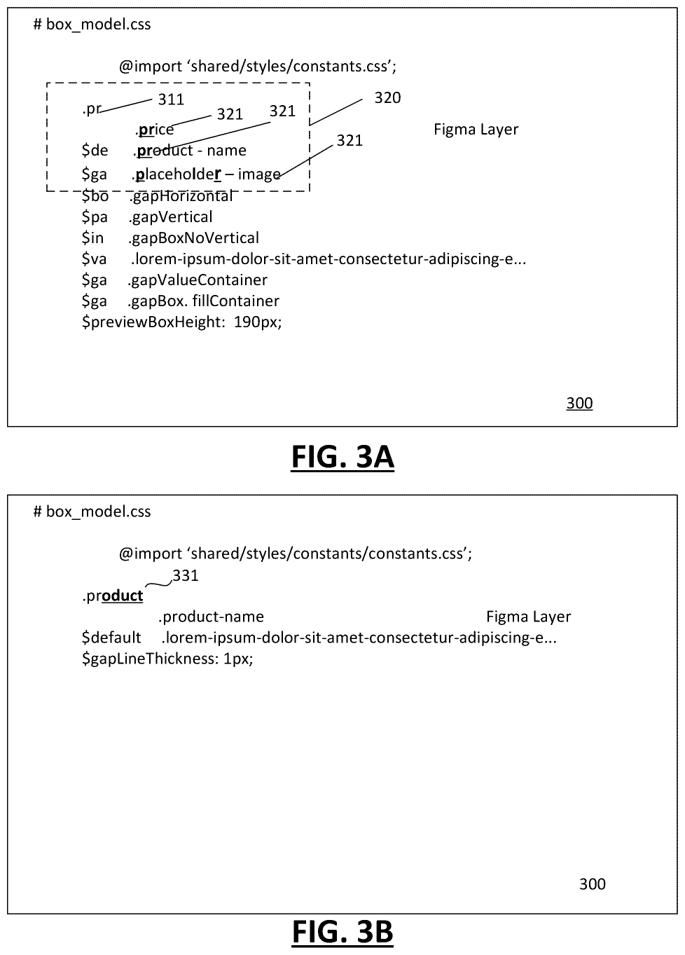

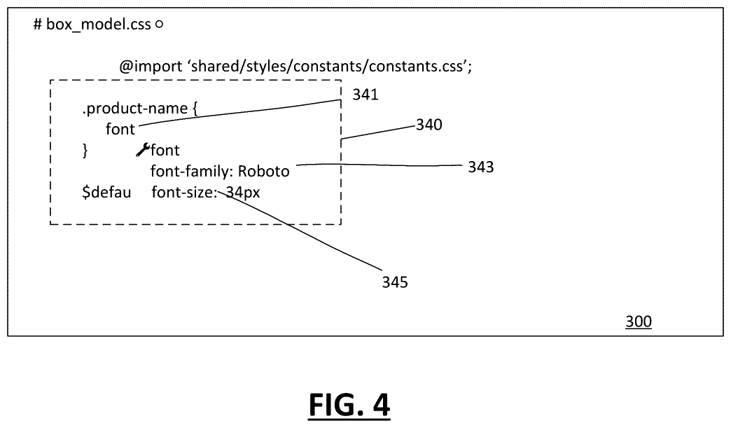

FIG. 3A through FIG. 3B and FIG. 4 illustrate an example of a code editor interface, operating to implement a code autocomplete feature, according to one or more embodiments. Examples of FIGS. 3A, 3B and 4 can be implemented using, for example, a graphic design system 100 of FIG. 1, and/or in accordance with a method such as described with FIG. 2.

With reference to FIG. 3A, a code editor interface 300 receives a character entry input 311 (e.g., ‘pr’) from a user (e.g., developer). As described, the search component 142 performs a matching operation to match the character entry input 311 to a candidate set of entries, which are returned to and displayed by the code editor interface. In response to a partial code line entry 311, the code editor interface 300 displays a set of candidate code line entries. The candidate code line entries can be displayed, for example, in a panel or space 320 under or adjacent to the code line entry 311. For each candidate code line entry, the character entry input 311 can be matched to a term 321 (e.g., ‘price’, ‘product-name’, ‘placeholder’, etc.) that forms a portion of a corresponding code line entry 323. As described with other examples, the candidate code line entries (or snippets) can be suggestions to influence the user in writing code for implementing the graphic design 135 in a production environment. For example, the user can make a selection of a candidate code line entry from the recommended set, in order to complete a code line segment that the user has started writing with the character entry 137.

In an example FIG. 3B, the code editor interface 300 is shown to autocomplete a portion (or snippet) of the code line entry corresponding to, for example, a matched term. In the example shown, the autocomplete feature completes the code snippet 331 by replacing “pr” (user's character entry) with “.product”. The user can accept the autocompleted snippet by, for example, providing selection input (e.g., user hits ENTER or TAB on their keyboard). The term that is used in the autocomplete operation can correspond to, for example, an identifier of a layer of the graphic design.

With reference to FIG. 4, a code editor interface 300 receives one or more character entries (e.g., ‘f’, ‘fo’, . . . or ‘font’) from a user. The search component 142 can match the character entry to any one of multiple candidate terms (e.g., ‘font’, ‘font-family’, ‘font-size’, etc.) with each of the matching terms corresponding to, for example a property type. The search component 142 can identify a term corresponding to one or more types of values for one or more of the identified terms 343 (e.g., string or identifier), as well as a combination of attribute and value (e.g., font-size: 34 px) for one or more of the identified terms. The matching candidate terms can comprise a code snippet or code line entry (or portion thereof) that is displayed for the user in a space 340. A user can select to auto complete by selecting one of the candidates in the space 340.

### Network Computer System

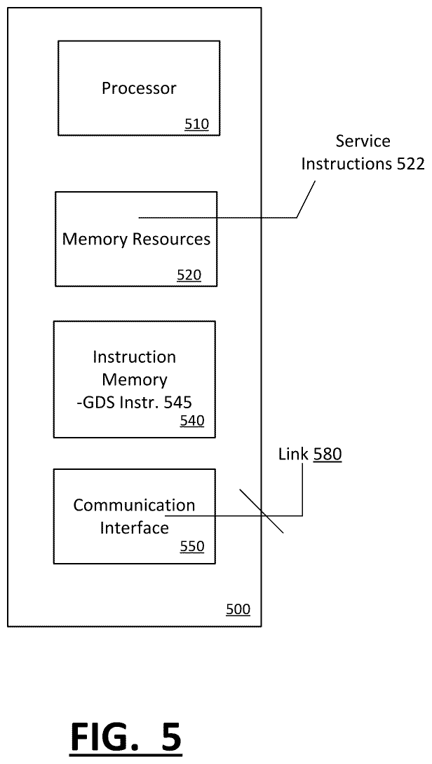

FIG. 5 illustrates a computer system on which one or more embodiments can be implemented. A computer system 500 can be implemented on, for example, a server or combination of servers. For example, the computer system 500 may be implemented as a network computing system 150 of FIG. 1.

In one implementation, the computer system 500 includes processing resources 510, memory resources 520 (e.g., read-only memory (ROM) or random-access memory (RAM)), one or more instruction memory resources 540, and a communication interface 550. The computer system 500 includes at least one processor 510 for processing information stored with the memory resources 520, such as provided by a random-access memory (RAM) or other dynamic storage device, for storing information and instructions which are executable by the processor 510. The memory resources 520 may also be used to store temporary variables or other intermediate information during execution of instructions to be executed by the processor 510.

The communication interface 550 enables the computer system 500 to communicate with one or more user computing devices, over one or more networks (e.g., cellular network) through use of the network link 580 (wireless or a wire). Using the network link 580, the computer system 500 can communicate with one or more computing devices, specialized devices and modules, and/or one or more servers.

In examples, the processor 510 may execute service instructions 522, stored with the memory resources 520, in order to enable the network computing system to implement a network service and operate as the network computing system 150.

The computer system 500 may also include additional memory resources (“instruction memory 540”) for storing executable instruction sets (“GDS instructions 545”) which are embedded with web-pages and other web resources, to enable user computing devices to implement functionality such as described with the GDS 100.

As such, examples described herein are related to the use of the computer system 500 for implementing the techniques described herein. According to an aspect, techniques are performed by the computer system 500 in response to the processor 510 executing one or more sequences of one or more instructions contained in the memory 520. Such instructions may be read into the memory 520 from another machine-readable medium. Execution of the sequences of instructions contained in the memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

### User Computing Device

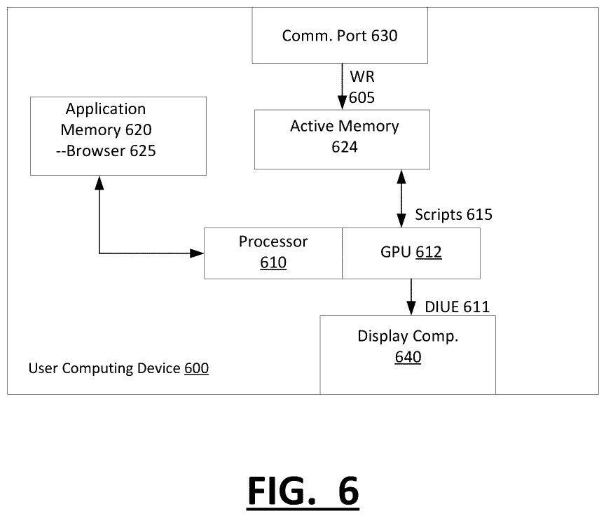

FIG. 6 illustrates a user computing device for use with one or more examples, as described. In examples, a user computing device 600 can correspond to, for example, a work station, a desktop computer, a laptop or other computer system having graphics processing capabilities that are suitable for enabling renderings of design interfaces and graphic design work. In variations, the user computing device 600 can correspond to a mobile computing device, such as a smartphone, tablet computer, laptop computer, VR or AR headset device, and the like.

In examples, the computing device 600 includes a central or main processor 610, a graphics processing unit 612, memory resources 620, and one or more communication ports 630. The computing device 600 can use the main processor 610 and the memory resources 620 to store and launch a browser 625 or other web-based application. A user can operate the browser 625 to access a network site of the network computing system 150, using the communication port 630, where one or more web pages or other resources 605 for the network computing system (see FIG. 1) can be downloaded. The web resources 605 can be stored in the active memory 624 (cache).

As described by various examples, the processor 610 can detect and execute scripts and other logic which are embedded in the web resource in order to implement the GDS 100 (see FIG. 1). In some of the examples, some of the scripts 615 which are embedded with the web resources 605 can include GPU accelerated logic that is executed directly by the GPU 612. The main processor 610 and the GPU can combine to render a design interface under edit (“DIUE 611”) on a display component 640. The rendered design interface can include web content from the browser 625, as well as design interface content and functional elements generated by scripts and other logic embedded with the web resource 605. By including scripts 615 that are directly executable on the GPU 612, the logic embedded with the web resource 615 can better execute the GDS 100, as described with various examples.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A computer-implemented method comprising:
maintaining a data store that includes searchable information for a graphic design, the searchable information including text-based information that includes terms and values for a collection of layers that comprise the graphic design, wherein each layer corresponds to an object, group of objects or a type of object, and each layer is associated with a set of attributes, including a text identifier;
receiving, via a code editor interface, a sequence of character entries;
performing a matching operation to match the character sequence to a term and/or value of the text-based information for one or more layers of the collection;
determining a predicted or matched code line entry based on the term, value or combination of term(s) and value(s); and
providing, to the code editor, the predicted or matched code line entry, so as to autocomplete a portion of a code line entry with the predicted or matched code line entry.

2. The computer-implemented method of claim 1, wherein the predicted or matched code line entry includes a text identifier of a layer of the collection.

3. The computer-implemented method of claim 1, wherein the predicted or matched code line entry corresponds to an attribute value of a layer of the collection.

4. The computer-implemented method of claim 1, wherein receiving the partial code line entry includes receiving, over one or more networks, the code line entry over an application program interface; and
wherein providing the predicted code line entry includes transmitting, over the application program interface, the predicted or matched code line entry.

5. The computer-implemented method of claim 1, wherein the predicted or matched code line entry is based at least in part on the text identifier of the matched layer.

6. The computer-implemented method of claim 1, wherein performing the matching operation includes determining a set of candidate code line entries from one or more terms and/or values of the collection, and selecting the predicted or matched code line entry from the candidate set based on one or more weighting factors of the set of candidate code line entries.

7. The method of claim 6, wherein the weighting factors are based on a node or layer of at least one code line entry of the candidate set.

8. The method of claim 6, wherein the weighting factors include a frequency or count, within the data store, of individual terms or values that match the one or more entries.

9. The method of claim 6, wherein the method further comprises receiving an additional set of one or more characters for the partial character sequence; and wherein performing the matching operation includes narrowing the set of set of candidate code line entries based on the additional set of one or more characters.

10. The method of claim 1, wherein performing the matching operation includes:
determining a portion of the graphic design that corresponds to a location of the code representation where the partial code line entry is made; and
wherein the matched term and/or value is included with the determined portion of the graphic design.

11. The method of claim 1, wherein the predicted or matched code line entry includes an attribute identifier of the matched layer.

12. The method of claim 1, wherein the predicted code or matched line entry includes a value that is based on an attribute of the matched layer.

13. A computer system comprising:
one or more processors;
a memory to store instructions;
wherein the one or processors store instructions to perform operations comprising:
maintaining a data store that includes searchable information for a graphic design, the searchable information including text-based information that includes terms and values for a collection of layers that comprise the graphic design, wherein each layer corresponds to an object, group of objects or a type of object, and each layer is associated with a set of attributes, including a text identifier;
receiving, via a code editor interface, a sequence of character entries;
performing a matching operation to match the character sequence to a term and/or value of the text-based information for one or more layers of the collection;
determining a predicted or matched code line entry based on the term, value or combination of term(s) and value(s); and
providing, to the code editor, the predicted or matched code line entry, so as to autocomplete a portion of a code line entry with the predicted or matched code line entry.

14. The computer system of claim 13, wherein the predicted or matched code line entry includes a text identifier of a layer of the collection.

15. The computer system of claim 13, wherein the predicted or matched code line entry corresponds to an attribute value of a layer of the collection.

16. The computer system of claim 13, wherein receiving the partial code line entry includes receiving, over one or more networks, the code line entry over an application program interface; and
wherein providing the predicted code line entry includes transmitting, over the application program interface, the predicted or matched code line entry.

17. The computer system of claim 13, wherein the predicted or matched code line entry is based at least in part on the text identifier of the matched layer.

18. The computer system of claim 13, wherein performing the matching operation includes determining a set of candidate code line entries from one or more terms and/or values of the collection, and selecting the predicted or matched code line entry from the candidate set based on one or more weighting factors of the set of candidate code line entries.

19. The computer system of claim 18, wherein the weighting factors are based on a node or layer of at least one code line entry of the candidate set.

20. A non-transitory computer-readable medium that stores instructions, which when executed by one or more processors of a computer system, cause the computer system to perform operations comprising:
maintaining a data store that includes searchable information for a graphic design, the searchable information including text-based information that includes terms and values for a collection of layers that comprise the graphic design, wherein each layer corresponds to an object, group of objects or a type of object, and each layer is associated with a set of attributes, including a text identifier;
receiving, via a code editor interface, a sequence of character entries;
performing a matching operation to match the character sequence to a term and/or value of the text-based information for one or more layers of the collection;
determining a predicted or matched code line entry based on the term, value or combination of term(s) and value(s); and
providing, to the code editor, the predicted or matched code line entry, so as to autocomplete a portion of a code line entry with the predicted or matched code line entry.
